(19) United States
(12) Patent Application Publication
(10) Pub. No.: US 2023/0088606 A1
(43) Pub. Date: Mar. 23, 2023

(54) ENHANCED MOISTURE CONTROL DEVICES FOR THE PRESERVATION OF PRODUCTS IN CLOSED ENVIRONMENTS

(71) Applicant: Boveda Inc., Minnetonka, MN (US)

(72) Inventors: Tina M. O'Shea, Minnetrista, MN (US); Justin W. Lilley, Edina, MN (US); John T. Nguyen, Apple Valley, MN (US); Robert L. Esse, Monticello, MN (US); Jonathan W. DeVries, Coon Rapids, MN (US); Brian Rice, Greenfield, MN (US)

(73) Assignee: Boveda Inc., Minnetonka, MN (US)

(21) Appl. No.: 17/947,762

(22) Filed: Sep. 19, 2022

Related U.S. Application Data
(60) Provisional application No. 63/245,316, filed on Sep. 17, 2021.

(51) Int. Cl. B65D 81/22; B65D 81/32; B65D 81/26; A24F 25/02

(52) U.S. Cl. CPC B65D 81/22; B65D 81/3266; B65D 81/268; A24F 25/02

(57) ABSTRACT

Devices and methods for controlling humidity including an aqueous saturated solution of a salt and/or a sugar in combination with an additive in which all components of the saturated solution are food grade. The device may or may not include a container, such as a flexible pouch, encasing the aqueous saturated solution and/or an absorbent pad. The pouch or other container may be made of a material which is moisture permeable and liquid impermeable, for example, and the aqueous saturated solution further comprises a thickening agent. In some embodiments, the components of the aqueous saturated salt solution are separately contained in different compartments of the device container, and a user may activate the device to mix the components together.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many products and items benefit from a controlled humidity environment. In particular, many products and items benefit from an environment having a humidity content, such as a relative humidity, within a particular range or at a particular level. Some products and items can spoil, become damaged, become unusable, or lose freshness when subject to environments with too much or too little humidity. For example, tobacco products, such as cigars or loose tobacco, can benefit from an environment with a controlled humidity. Similarly, cannabis products, such as loose cannabis, pre-rolled cannabis products, or other products can benefit from an environment with a controlled humidity. Pharmaceutical or medicinal products can benefit from a controlled humidity environment. Food products may also benefit from such environments. Instruments, such as stringed instruments, can also benefit from such environments. Many other products and items may benefit from a controlled humidity as well.

Additionally, some products may require a particular humidity level or range in order to remain safe for consumers. For example, some products may need to be kept at or below a particular humidity level in order to ensure they are safe for consumption. In some cases, particular rules, regulations, or product standards or specifications may designate a safe or required humidity level or humidity range for products. To help maintain a desired or required humidity level or range for products, it may be desirable to control a humidity level within a product package or container in which such products or items are stored. Conventionally, products are often provided with desiccants or moisture absorbing materials to dehumidify a product package environment. However, desiccants alone do not control humidity within a desired range or at a desired rate.

### SUMMARY

Various embodiments include devices and methods for controlling humidity. In some embodiments, the humidity control device includes an aqueous saturated solution of a salt and/or a sugar in combination with an additive in which all components of the saturated solution are food grade. The device may or may not include a container, such as a flexible pouch, encasing the aqueous saturated solution. Such a pouch may be made of a material which is moisture permeable and liquid impermeable, for example. In some embodiments, the aqueous saturated solution further comprises a thickening agent.

In some embodiments, the humidity control device may also include an absorbent pad within the pouch. In some such embodiments, the saturated solution does not include a thickening agent. The absorbent pad may be a blotter paper or a rayon material, for example. In other embodiments, the humidity control device may include an absorbent pad, and the aqueous saturated solution may be contained by pores of the absorbent pad without an encasing package.

In other embodiments, the humidity control device may include a package with two separate compartments that are not in communication with each other. Prior to activation by a user, the components of the saturated salt solution may be separated between the two compartments. A first portion of the aqueous saturated salt solution including one or more first components of the aqueous saturated salt solution may be contained within the first compartment, and a second portion of the aqueous saturated salt solution including one or more second components of the aqueous saturated salt solution is contained within the second compartment. When the first portion and the second portion are combined by activation by a user, the aqueous saturated solution is formed. For example, the first compartment may contain water and the second compartment contains no water. In some such embodiments, the second compartment may contain the salt and/or sugar.

In some embodiments, the aqueous saturated solution also includes gelatin, pectin or a gum. In some such embodiments, there is no container enclosing the aqueous saturated solution.

In some embodiments, the aqueous saturated solution also includes sorbitol, and the humidity control device hardens in response to decreasing water in the aqueous saturated solution,

Other embodiments include methods of controlling humidity, such as in a closed container or package. In some embodiments, the method includes placing any of the humidity control devices described above in a container or package and closing the container. All of the components of the humidity control device may be food grade, and the package or container may also include a consumable product, such as a food or a medicine. The method may also include storing the closed container or package with the enclosed humidity control device in a refrigerator or a freezer.

Other methods include activating a humidity control device including a first compartment and a second compartment which are separated from each other. The first compartment may contain water, and the second compartment may contain a salt and/or sugar. A user may activate the humidity control device by manually altering the container to bring together the contents of the first and second compartments to form the aqueous saturated solution. The user may then place the activated humidity control device in a location at which controlled humidity is desired. For example, the user may manually alter the container by breaking the first and/or the second compartment. In other embodiments, the container may include a closed passage between the first and the second compartments, and the user may manually alter the container by opening the passage between the first and the second compartments.

### FIGURES

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a cross section view of a humidity control device according to various embodiments;

FIG. 2 is a transparent side view of a humidity control device according to various embodiments;

FIG. 3 is a transparent top view of a humidity control device according to various embodiments;

FIG. 4 is a side transactional view of the humidity control device of FIG. 3;

FIG. 5 is a graph of aroma intensity versus water activity from Experiment 1;

FIG. 6 is a bar graph depicting aroma pleasantness results from Experiment 1;

FIG. 7 is a bar graph depicting the amount of terpenes in samples from Experiment 2;

FIG. 8 is a bar graph depicting the amount of monoterpenes in samples from Experiment 2;

FIG. 9 is a bar graph depicting the amount of limonene in samples from Experiment 2;

FIG. 10 is a bar graph depicting the amount of myrcene in samples from Experiment 2;

FIG. 11 is a bar graph depicting the amount of sesquiterpenes in samples from Experiment 2;

FIG. 12 is a graph of humidity control over time at zero degrees F. using a Boveda humidity control device;

FIG. 13 is a graph of humidity control over time at 32 degrees F. using a Boveda humidity control device; and

FIG. 14 is a graph of humidity control over time at 72 degrees F. using a Boveda humidity control device.

### DETAILED DESCRIPTION OF THE INVENTION

The present application claims priority to provisional application No. 63/245,316, entitled Enhanced Moisture Control Devices for the Preservation of Products in Closed Environments, the disclosure of which is hereby incorporated by reference in its entirety. Various embodiments include improved and enhanced humidity control devices. The humidity control devices include a humidity control component such as a solution such as an aqueous saturated salt or sugar, or a gel enclosed within a container such as a moisture permeable which may also be liquid impermeable. The container may be a flexible container such as sachet or packet, for example, or a more rigid container such as a capsule or tube. The humidity control devices may be used to maintain a product at a desired level or moisture, to prevent unwanted drying or unwanted humidification.

Various embodiments may be used to control the humidity in the environment of consumable items such tobacco, and cannabis as well as other consumable and non-consumable items which are subject to degradation such as wood items like instruments, works of art, artifacts, cabinets such as gun cabinets, guns, and collectible products including paper-based products such as sports memorabilia cards like baseball cards. Among food items with which various embodiments may be used are coffee, tea, fruits, vegetables, and candy such as gummy candies. Various embodiments can also be used to maintain a fresh and crunchy character of food such as nuts and a crispy freshness of foods such as vegetables or enhance other qualities of the product. Various embodiments may be used with cannabis, hemp and cannabis and hemp products.

Various embodiments provide a device for controlling the relative humidity in an environment for foods and other products. In some embodiments, all components of the humidity control solution may be food grade and may be essentially odorless. All of the components of the humidity control solution and/or all of the components of the device may be selected to be odorless. In some embodiments, the odorless humidity control solution may include glycerin and/or may exclude lactate.

Some embodiments of the present invention may utilize a saturated aqueous solution of a solute such as an edible salt or a sugar or another soluble compound that may help to create a desired and/or specific, or specific range of relative humidity in the air space adjacent to the humidity control device. The solution may include a substantial amount of water in a fluid form as a saturated salt solution. The solution may further include a gel forming material such as an alginate or xanthan. The combination of vegetable gum, water and salt provides a highly viscous fluid. The viscous solution may be contained in a polymeric pouch in some embodiments. The polymeric pouch may be of a thin film of polyethylene (high density or low density), oriented polystyrene or the like. The pouch may be made from a film laminated to paper, non-woven polyester, or any suitable substrate. The pouch may be of nylon film or of a styrene-butadiene copolymer. The solution may be a hydrocolloid including soluble gums (alginate, xanthan, pectin), a protein gel (egg albumen, gelatin) and/or inorganic polymer (silicate). The pouch may further contain an oxygen scavenging material dispersed in the solution or separated from the solution.

Various embodiments include humidity control devices including a polymeric pouch or packet, such as in the form of a flexible film container having folded or sealed outer edges, for example, having walls sufficiently permeable to permit migration of water through the film in the form of water vapor and yet thick enough to prevent the escape of liquid water, and a solution including an organic or an inorganic solute (e.g., salt or sugar) and water and other optional components such as vegetable gum. The humidity control device in some embodiments may include an oxygen scavenging material dispersed in a combination of solute and water and optionally may include, for example, vegetable gum. The humidity control device may optionally include a case with a plurality of openings.

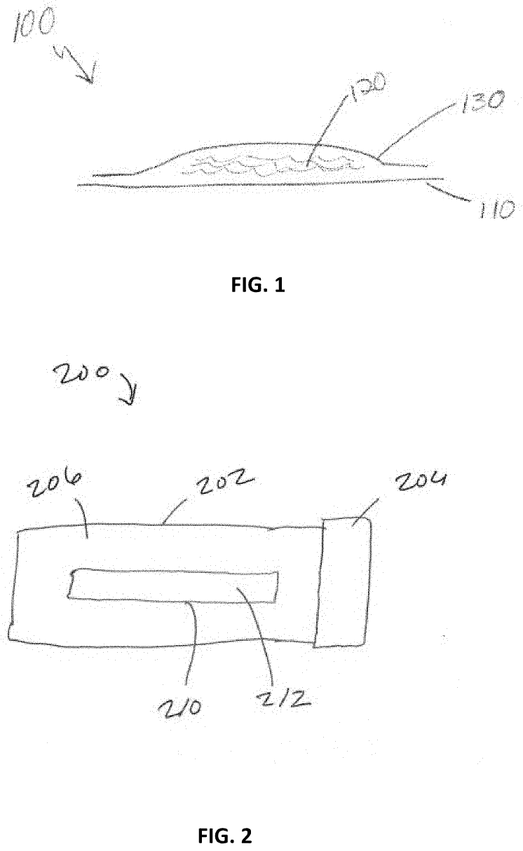

An example of a humidity control device which may be used in various embodiments is shown in FIG. 1. In this example, the humidity control device 100 is a packet and includes a base layer 110 and a top layer 130 connected to each other around their periphery such as by adhesive or a heat seal, enclosing the humidity control agent 120 between the two layers. The base layer 110 and the top layer 130 may be the same material or different materials. Either the base layer 110 or the top layer of both layers may be moisture permeable and liquid impermeable as described herein.

The saturated solution may contain excess solute (e.g., salt or sugar crystals) and in some embodiments may be made more viscous with a thickening agent. In some embodiments, the solution does not form large crystals within its matrix as it releases water vapor to the product, such as tobacco, cannabis, or hemp products. For example, some such products which do not form crystals may include glycerin, which may reduce or prevent crystal formation and may be odorless. In some select situations, a fungicide or inhibitor such as an oxygen absorber or ethylene absorber and/or a small amount of a buffering salt mixture may be desirable.

The solution used in various embodiments may include any suitable solute which has a saturated solution at 20% solute in water (percent by weight of solute in weight of solution) as a minimum and any solute that will provide a saturated solution at 75% solute in water (percent by weight of solute in weight of solution) as a maximum, such as a range of solubility from 25 to 80%. For example, the saturated solution may contain 60% solute and 40% water to 30% solute and 70% water, or up to a range of a saturated solution as low as 5% solute and as high as 90% solute by weight. One example of a suitable solution may include a 50/50 combination of ammonium nitrate and potassium chloride. This solution will provide a relative humidity slightly less than 70%. Some acids (e.g., 2% citric acid) may be added to lower the pH, for example to pH 5 or lower, to convert any free ammonia to the ammonium ion.

Some sugars may be suitable for use as a humidity control agent. Sucrose, glucose and fructose are environmentally sustainable and work well such as for disposable pouches. Sodium chloride is one of the preferred salts which is used in a large range of applications because of its humidity (CA 75%), good solubility (25%), non-toxicity, and cost. Other salts or solutes may be used alone or in combination if a different humidity is desirable.

The salt and sugar solutions of various embodiments may be thickened with a thickening agent such as a vegetable gum or other hydrocolloid. The thickening agent may be prehydrated prior to the process formulation or may be hydrated as part of the manufacturing process. The thickening agent may be selected for its suitability for use in a concentrated salt solution. Useful thickeners include propylene glycol alginate and brine tolerant xanthan. Other usable vegetable gums include but are not limited to pectin, guar, arabic, tragacanth, starches, proteinaceous gels, egg albumin, modified celluloses. or alumina, among others. Some microbial gums which are usable include but are not limited to gellan and xanthan. Some seaweed gums which may be used include but are not limited to carrageenan, alginate such as sodium alginate or calcium alginate. Some synthetic gums which are usable are: carboxymethyl cellulose, propyleneglycol cellulose, and hydroxypropyl methylcellulose (HPMC). Since many of these gums may be unstable thickeners for saturated salt solutions, the resulting syneresis of saturated salt solutions may require substantially 100% integrity of pouch seals. Concentrations of 0.5 to 2% of the total solution may give viscosity ranges in excess of 2500 cps (centipoise) which is acceptable to an actual gel. Such a viscosity is adequate to maintain a uniform suspension of the excess solute during filling of the pouches with the solution. A thixotropic or shear thinning gel may be used for manufacturing purposes. While viscosities between 1500 cps and 7500 cps or between 1500 cps and 15000 cps will work. Viscosities of less than 2500 cps may be used with proper seals at the seams. The optimal range of viscosity may vary depending upon the type of material used and the packaging. For example, for humidity control devices including a saturated material such as a saturated pad, the viscosity may be about 0 to about 400 csp. For humidity control devices having flexible outer packaging, the viscosity may be about 400 to about 1800 csp. For humidity control devices having a rigid outer packaging, the viscosity may be about 1800 to about 5000 csp. Hydrocolloid systems that form non-flowing gels are usable as well. In some embodiments, the saturated salt or polyhydroxy organic compound slurry may have a viscosity from 1 cps to 10,000 cps and may be controlled by using 0.1% to 2% of a thickening agent.

Various salts may be used to prepare the salt solution. For example, the solute may be a single salt such as sodium chloride, sodium nitrite, potassium nitrite or a mixture of salts such as 50/50 or other ratios of potassium chloride and ammonium nitrate or a non-ionic compound such as sugar such as sucrose. As another example, approximately a 50/50 by weight combination of potassium chloride and ammonium nitrate or ammonium carbonate and calcium chloride are suitable.

The water activity control formula of the devices may contain a slurry of saturated salt in water composed of any of several different anions and cations, singly or in almost any combination along with additives to achieve a desired relative humidity/water activity control. Several different anions and cations in almost any combination can be combined to produce the desired salt solutions. Monobasic anions such as acetate, bicarbonate, bisulfate, bromide, chloride, dihydrogen phosphate, fluoride, formate, iodide, lactate, nitrate, nitrite, phosphate and sulfate may be used, for example. Anions which may be used also include salts of polybasic acids such as carbonic, citric, maleic, malic, monohydrogen phosphate, phosphoric, succinic, and sulfuric. Other anions which may be used include, but are not limited to, dihydrogen phosphate, bicarbonate, carbonate, sulfate, and bisulfate, among many others. The cations which may be used include lithium, sodium, potassium, rubidium, cesium, magnesium, calcium, ammonium, strontium, and barium, among others. Some of the polybasic acids which can be used are citric, maleic, malic, and succinic, for example. Salts of polybasic acids which may be used include, but are not limited to, potassium citrate, sodium citrate, sodium formate, sodium malate, and sodium tartrate.

The water activity control formula may contain polyhydroxy organic compounds such as glycerin, sugars, or sugar alcohols. Sugars, sugar alcohols, polybasic acids, and salts of polybasic acids may also be used to produce the desired solutions. Some of the sugars which may be used are sucrose, fructose, glucose, galactose, maltose, lactose, etc. Some of the sugar alcohols which may be used are sorbitol, xylitol, mannitol, and erythritol, for example. Other polyhydroxy organic compounds which may be used include but are not limited to glycerin and propylene glycol.

Several different compounds are usable for creating the solutions. The following list is only a partial list of the compounds which are usable: lead chlorate, lead perchlorate, manganese chloride, mercuric nitrate, potassium dichromate, potassium permanganate, sodium chromate, aluminum nitrate, ammonium chloride, ammonium dihydrogen phosphate, ammonium bi-sulfite, barium bromide, cobalt sulfate, copper sulfate, copper nitrite, ferrous sulfate, and ferric bromide. Some combinations of anions can be reactive, unless the pH is maintained either on the basic side, or on the acid side of pH 7.0, thus suitable buffer systems will be required to prevent undesirable reactions.

A solution of sodium chloride may be used to provide a relative humidity at about 74% in some embodiments. The relative humidity measurements described herein are calculated at 70° F. If the humidity starts to fall below 74%, the salt solution gives up water to provide moisture to the air until the air reaches a relative humidity of 74%. The water vapor transfers through the wall of the polymeric pouch (and out through the various openings in the protective pouch case, if present). On the other hand, if the moisture in the air surrounding the present device rises above 74% relative humidity, the salt solution will pick up moisture from the air lowering the relative humidity to approximately 74%. A solution of sodium chloride with excess solid crystals of sodium chloride may be used to provide a relative humidity of about 74%.

Some examples of humidity levels possible with single and mixtures of solutes are listed below. Some solutes that produce/maintain humidity levels in the 90% or higher range are: potassium sulfate at 97%; potassium nitrate at 92%; cesium iodide at 91%; and barium chloride at 90%. Some solutes that produce/maintain humidity levels between 80% and 89% are: potassium chloride at 84%; sucrose at 84%; ammonium sulfate at 81%; and potassium bromide at 81%. Some solutes that produce/maintain humidity levels between 70% and 79% are: sodium nitrate at 74%; sodium chloride at 74%; and strontium chloride at 71%. Some solutes that produce/maintain humidity levels between 60% and 69% are: potassium iodide at 69% and sodium nitrite at 66%. Some solutes that produce/maintain humidity levels between 50% and 59% are: sodium bromide at 58%; sodium dichromate at 55%; and magnesium nitrate at 53%. A solute that produces/maintains humidity levels in between 40% and 49% is potassium carbonate at 44%. Some solutes that produce/maintain humidity levels in between 30% and 39% are: sodium iodide at 38% and magnesium chloride at 33%. A solute that produces/maintains humidity levels in between 20% and 29% is calcium chloride at 29%. Some solutes that produce/maintain humidity levels between 6% and 18% are: lithium iodide at 18%; lithium chloride at 11%; potassium hydroxide at 9%; zinc bromide at 8% and lithium bromide at 6%.

Other salts or combinations of salts can be used to obtain virtually any relative humidity. For example, a solution of sodium chloride, potassium nitrite and sodium nitrite of equal molar portions has a relative humidity of 31%. As another example, a solution of ammonium chloride and potassium nitrate has a relative humidity of 72%. Another suitable solute includes by weight 2 parts of sodium chloride and 1 part sodium nitrite which results in a relative humidity of 71%. Other embodiments may provide a relative humidity of less than 32%. Still other embodiments may provide a relative humidity of greater than 84%.

The components of the saturated solution may be selected to achieve a desired relative humidity or relative humidity range. For example, the solution may be selected to control the relative humidity in the air surrounding the device in a sealed container, and thus the water activity of the product such as the cannabis or hemp product, from a relative humidity of about 10% to about 90%, or from a relative humidity of about 55% to about 65%. In some embodiments, particular solutions may be selected to achieve a specific desired relative humidity, such as a relative humidity of 60%.

The precise control of relative humidity may not only enhance various qualities of tobacco, cannabis and hemp products, for example, but may also improve preservation. For example, the water activity formula of the devices may control the surrounding relative humidity and thus the water activity of tobacco, cannabis and hemp products at temperatures normally used to process and store the tobacco, cannabis and hemp and their products. In some embodiments, the water activity formula of the devices may include a slurry of saturated salt in water along with other additives formulated to provide rapid equilibration of relative humidity in the atmosphere of a sealed container surrounding the product to be protected or preserved, such as cannabis, hemp, or a cannabis or hemp product.

In some embodiments, one or more components may be added to the solution as a curing agent.

In some embodiments, the device may optionally include a surfactant. The surfactant may be combined with the humidity control solution or may be separate. Examples of surfactants which may be used include anionic surfactants, neutral surfactants, and cationic surfactants. Anionic surfactants which may be used include fatty acid anions paired with, among other things, cations such as ammonium, sodium, or potassium cations. Neutral surfactants which may be used include polymeric ethylene oxide-based surfactants. Cationic surfactants which may be used include quaternary ammonium-based surfactants paired with, among other anions things, chloride anions. In some embodiments, the surfactant may be polyethoxylated sorbitan monolaurate (PSML) and/or polyethoxylated sorbitan stearate, for example, which may induce phase changes and increase the release of water. In some embodiments, the surfactant may be present in the water activity control formula at a concentration from 0.005% to 1% to expedite equilibration of the relative humidity surrounding the control formula and thus the water activity of the product such as cannabis, hemp or cannabis or hemp product.

In other embodiments, the device may optionally include a defoamer or anti-surfactant. The defoamer or anti-surfactant may be combined with the humidity control solution or may be separate. Examples of defoamers or anti-surfactants which may be used include silicone based defoamers. Defoamers may act as processing aids during production of the device, such as to control bubbling or foaming, such as may occur in solutions containing surfactants. In some embodiments, the anti-surfactant may be present in the water activity control formula at a concentration of about 0.01% to 0.1%, such as about 0.05%.

The control of humidity provided by the devices through a particular formulation and combination of ingredients may improve the qualities and preservation of products, such as tobacco, cannabis and hemp and their products. In some embodiments, the device may improve the preservation of terpenes, such as the terpenes found in cannabis as well as other organic plant materials. It may also provide improved aroma preservation and/or aroma enhancement. The device may do this by providing appropriate levels of relative humidity in the environment in which the tobacco, cannabis or hemp is stored. For example, the terpenes and their aromas may be better preserved, and may be more pleasant, in products such as tobacco, and may help it maintain a relative humidity of 65%, 69%, 72% or 75%, for example. Likewise, the terpenes and their aromas may be better preserved, and may be more pleasant in cannabis, for example, and help it maintain a relative humidity of approximately 62%, while still maintaining control of microorganisms for product safety. In some embodiments, the humidity control device may be used to store the tobacco, cannabis, or hemp and improve aroma preservation by a factor of twenty times as compared to tobacco, cannabis or hemp stored without humidity control.

In some embodiments, storing the tobacco, cannabis or hemp at a controlled relative humidity may increase the perception of more pleasant aromas in the product. For example, aromas such as woody, herbal and fruity scents may be more prominent in cannabis and hemp when the materials are ground after being stored with humidity control devices disclosed herein

In addition, or alternatively, the device may preserve the quantity or quality of the terpene content or include components which enhance the terpenes of the product. For example, the device may include added terpenes. The added terpenes may be present in the moisture control solution or may be separated from the moisture control solution in the device. Alternatively, or additionally, the device may include terpene precursors in the moisture control solution and/or separate from the moisture control solution. In some embodiments, the device may preserve the quantity and quality of the cannabinoid content of products by controlling the relative humidity of the environment in which the product is stored. In some embodiments, the device may preserve the quantity and quality of the flavonoid content of products by controlling the relative humidity in which the product is stored. In some embodiments, the device may preserve the color of products.

In some embodiments, the device may include components which are complementary compounds. For example, the device may include compounds which are complementary to terpenes. In some embodiments, the device may include complementary compounds to increase the perception of freshness.

In some embodiments, one or more components may be added to the solution to improve freshness and preservation of a product such as a food product. For example, one or more mold control agents may be included in the solution. For example, the presence of mold inhibitors such as potassium sorbate, calcium propionate, sodium propionate, sodium benzoate, in the humidity control solution, may inhibit mold growth. In addition, a concentrated solution of potassium sorbate or other inhibitor may be printed on the outside of the humidity regulator when graphics are applied to the humidity regulator to further reduce mold growth. For example, the potassium sorbate or other inhibitor may be present at a concentration of about 0.005% to about 0.03% in a printed application on the outside of the humidity regulator.

In other embodiments, the freshness and preservation provided by the humidity control devices may be enhanced through mechanisms which control the release of gas. The moisture control device may include a curing agent. In other examples, the moisture control device may include a ripening control agent. In some embodiments, the curing agent may be a ripening control agent. Examples of ripening control agents which may be used in various embodiments include manganates and other ethylene absorbing components. The use of ripening control agents may allow the packaged food, particularly fresh food such as fruits and vegetables, to be stored longer before spoiling. In some examples, the moisture control agent may release CO₂.

Ethylene absorbing agents may be used in humidity control devices which may be included with tobacco, cannabis and/or hemp during curing to reduce labor. Curing typically requires storage of the tobacco, cannabis or hemp in airtight containers for a period of time, during which gasses such as ethylene are released from the plant material into the container and must be periodically released by opening and then reclosing the containers to burp them. The humidity control devices with gas absorbing agents such as ethylene absorbers may be placed in the containers with the tobacco, cannabis or hemp to reduce or eliminate the need to burp the containers.

In other embodiments, the effect of released gas may be minimized through the use of an inert gas. The product headspace may be flushed and replaced with an inert gas such as nitrogen to displace the oxygen and/or ethylene and a humidity control device which may optionally include an ethylene absorbing agent that may be provided in the product package, such as in the product package headspace.

Various embodiments of the humidity control device used with smokable products such as tobacco, cannabis and hemp and their products, may be used to improve the smokability of the products, such as by better maintaining the natural components of the material such as the natural sugars and/or oils of the products and promoting proper aging. In some embodiments, the color of the ash after burning may provide an indication of the quality of the preservation of the natural smokable product. For example, an ash that is all white may indicate improved quality and low levels of, or absence of, impurities such as nitrogen and sodium phosphate. When the impurities are not avoided or removed such as by flushing them out during production, they may lead to a harsh taste or burn during use of the product.

In some embodiments, the pouch as described herein may be constructed of any polymeric material such as polyethylene, polystyrene, polyvinyl chloride, polybutylene, polycarbonate, cellophane, microporous polyethylene, microfibrous polyethylene, nylon and the like that will provide the porosity necessary for the movement of the water vapor and retention of liquid water. Suitable materials include polyvinylidene chloride—shrink wrap, polyvinyl chloride, microporous polyethylene and microfibrous polyethylene. Other suitable materials include but are not limited to K-Resin (from Phillips Petroleum), low density polyethylene if less than 0.3 mil thick, cellophane, and polystyrene films of 0.5 mu or less, thin polycarbonate, etc. The film from which the pouch is constructed may have a thickness of 0.75 to 1.5 mils, for example. In some embodiments, the film may be as thin as 0.15 mils or thinner. Depending upon the polymer from which the pouch is made, the film may have a thickness of 1 mil or greater, allowing sufficient moisture migration to take place through the film. As a general matter, thinner film may be preferred providing the strength of the film is sufficient to avoid rupture during normal use.

Films may be characterized by water vapor transfer rates, the preferred rate of water vapor transfer in the films of some embodiments may be as low as 0.3 grams per 100 square inches per 24 hours in situations where there is little or no change in temperature and the container is substantially sealed with negligible moisture vapor transmission. In various embodiments, the rate may be in the range of about 5 to about 90 grams per 24 hours per 100 square inches of film, or about 10 to about 90 grams per 24 hours per 100 square inches of file. In some embodiments, the preferred range may be about 60 to about 90 grams per 24 hours per 100 square inches of film, or about 75 to about 80, or about 76 to about 77 grams per 24 hours per 100 square inches of film. Because of the cost and manufacturing considerations, the useable range for many applications is 5 to 15 grams per 24 hours. Rates as low as 0.3 grams per 100 square inches per 24 hours may be used, such as if the chamber has very little, if any, permeation of moisture vapor through the walls or if a pouch with a very large surface area is built.

The humidity control devices for use with products such as tobacco, cannabis, and hemp and tobacco, cannabis and hemp products, may have many forms such as pouches, pads, tubes and other configurations. For example, pouches may be formed from a water vapor permeable and water and liquid impermeable membrane or film. Polymers used for the pouch may include but are not limited to high density polyethylene, microfibrous polyethylene, oriented polystyrene, polyvinylchloride, polyester, modified polyester, polystyrene, polytetrafluoroethylene, polyvinylidene chloride, polylactate, polyamides, polyurethane, ethylcellulose, cellulose acetate, polybutylene, polyethylene terephatlate, polyvinylchoride, nylon, polyvinylfluoride, polyethylenevinylacetate K-Resins, polyvinylalcohol, or combinations thereof. In addition, very thin versions of low-density polyethylene, or polypropylene and the like are also functional and may be used alone or in combination with any of the other potential materials but may lack strength but can be protected by a screen or a lower grade of a material like TYVEK film (microfiberous polyethylene). However, these thin films are more difficult to fabricate into pouches with leak-free seams. A variety of copolymers and laminates may also be used. Films can be made from rubbers with suitable properties as well.

The polymer used for the pouch may have a water vapor transmission rate such that the pouch transfers about 1% to about 50% by weight of the initial pouch contents in a 24-hour period when exposed to a relative humidity of less than 10% and absorbs from about 1% to about 50% by weight of the initial pouch content when exposed to an atmosphere having a relative humidity of greater than 85%.

While in some embodiments the solution may be contained by the pouch, in other embodiments the device may include an alternative media to hold the solution, with or without a surrounding pouch. For example, the device may include an alternate matrix such as a carrier which may be an absorbent carrier to hold the solution. Examples of such carriers include fiber pads or blocks which may be manufactured from various fibers including but not limited to bamboo, cannabis, hemp, straw, hay, sisal, cotton, non-woven polyester, and non-woven polyamide. The alternative matrices may have any convenient dimensions of length, width, thickness and shape. They may contain up to 99% of the total weight of the saturated salt or polyhydroxy organic compound slurry.

For example, the device may include an alternate matrix to serve as an adsorbent/absorbent carrier to hold the saturated solution. The adsorbent/absorbent matrix may have a high surface area to volume and a high surface area to weight ratio. For example, the adsorbent/absorbent carrier may have an absorbency of at least about 0.75 gram of formula per square inch, such as about 0.75 grams to about 1.0 grams per square inch of the carrier. This may ensure an adequate surface area is available to release and take up water vapor. However, this ratio might be dependent on the filling and packaging manufacturing limitations The matrix may be manufactured from material which may bind the saturated solution without interfering with the capacity of the saturated solution to accept water molecules from, or release water molecules to, the surrounding atmosphere to maintain a constant relative humidity. The material may have any convenient dimensions of length, width, thickness and shape with sufficient internal and external porosity to support the adsorbed/absorbed saturated solution while transferring water vapor. Materials of construction of the matrix may include but not be limited to fibers such as bamboo, cannabis, hemp, cotton or grain based, or fibrous synthetic materials such as non-woven polyesters, non-woven polyamides such as nylon or modified cellulosics such as rayon. The quantity of saturated solution adsorbed/absorbed to the matrix will range up to the maximum that can be adsorbed/absorbed.

In some embodiments, the alternative matrix may be wrapped or enclosed in a material or overwrap, such as a water vapor permeable, water and liquid impermeable membrane such as high density polyethylene, microfibrous polyethylene, oriented polystyrene, polyvinylchloride, polyester, modified polyester, polystyrene, polytetrafluoroethylene, polyvinylidene chloride, polylactate, polyamide or combinations thereof and/or any of the materials discussed elsewhere herein with regard to a membrane or film enclosure, such as a pouch, for example. The overwrap may have a water vapor transmission rate such that the pouch transfers about 1% to about 50% by weight of the initial pouch contents in a 24-hour period when exposed to a relative humidity of less than 10% and absorbs from about 1% to about 50% by weight of the initial pouch content when exposed to an atmosphere having a relative humidity of greater than 85%.

In some embodiments, the device includes a thin pad which is highly water absorbent such as highly water absorbent. For example, the thin pad may be made of a hydrophilic material such as bibulous paper, a cotton-based paper of high absorbency due to its spongy nature and unsized status. Examples of materials include woven or non-woven materials such as cellulose, rayon, cotton, or other polymeric materials or combinations thereof, which may optionally be treated or left untreated subsequent to manufacture to enable them to more readily absorb aqueous solutions. For example, the material may be selected and/or treated to increase absorption, such as through the use of hydrophilic fibers, selecting fibers of a particular diameter, and/or combing or orienting the fibers. The pad may be laminated between layers of permeable barrier film that will transmit moisture vapor but not liquid solution. Such pads may be about 0.01 to about 0.1 inches thick, such as about 0.01 to about 0.05 inches thick, or about 0.02 to about 0.04 inches thick, or about 0.02 to about 0.03 inches thick. The device may include a liquid or aqueous humidity control solution which may be absorbed by the pad and surrounded by a water vapor permeable and liquid impermeable membrane. During manufacture of the device, the pad holding the humidity control solution may be contained in the water vapor permeable and liquid impermeable membrane and may be compressed to remove air from the device, such as all of the air or substantially all of the air, while keeping the humidity control solution in the pad, and the membrane may then be sealed to make the device airtight. In some such embodiments, the humidity control solution may have less salt crystal formation or no salt crystal formation during use. The humidity control solution may be any humidity control solution as described herein. It may or may not include optional components such as glycerin and vegetable gum or any other additives described herein.

In some embodiments, including those for use with cannabis, hemp and cannabis and hemp products, including embodiments with or without pouches or pads, the water activity formula may be contained in a container such as a tube, capsule or other container which may be rigid. For example, the pouches and/or pads described above and elsewhere may be contained within a rigid tube. In some embodiments, the rigid tube may be water vapor permeable to a degree sufficient to function as a humidity control device at the desired level and to obtain the levels of preservation and quality control described herein. In some embodiments, the rigid tube may include an endcap on one or both ends, which may likewise be water vapor permeable as needed, while in other embodiments the rigid tube may not include endcaps.

In some embodiments, a casing suitable for use in the present invention is a tube for example of ⅝ to 3.25″ or smaller. The pouch may be placed within the cylinder and end caps placed on each end of the tube. The tube walls may have openings defined therein to permit the movement of water vapor through the tube walls. The pouch containing the salt gel may also be protected with an envelope, pouch, netting, or perforated plate that allows relatively free passage for water vapor yet protects the more fragile salt pouch from mechanical damage. Alternatively, the casing for the salt pouch may be impermeable except for a window through which water vapor can freely pass.

In some embodiments, the humidity control device includes a tube, such as the devices with tubes described above, which is sized and shaped for use with a product of the same size and shape as the tube, placed within a container of the products. For example, the device tube may have the same size and shape as a cigarette or hempette and may be inserted into a pack or box or other container of cigarettes alongside the cigarettes or hempettes of the same size to neatly fit within the container. When used with cigarettes or hempettes, such devices may be approximately 70 to approximately 120 mm long, or approximately 85 to 100 mm long, such as approximately 70 mm, 84 mm, 100 mm, or 120 mm long and approximately 5 to 8 mm, or approximately 5 to 6 mm or approximately 7.5 to 8 mm in diameter, for example. The container may be a standard size, such as a pack made for 20 cigarettes or hempettes, and one or more of the products may be replaced with a humidity control device. For example, a pack of cigarettes or hempettes sized to contain 20 cigarettes may instead include 19 cigarettes or hempettes and 1 humidity control device which includes a tube and is of the same size and shape as the cigarettes or hempettes (or 18 cigarettes or hempettes and 2 humidity control devices, etc.). In some embodiments, a humidity control device may be located in each corner of a container. For example, the pack of cigarettes or hempettes may include 16 cigarettes or hempettes and 4 tubular humidity control devices, with one device in each corner of the pack. In other embodiments, the container may be the same size as a standard container and may include the same amount of product as is normally contained in such a container but may still accommodate one or more humidity control devices. In still other embodiments, the container may be increased in size to accommodate the product and one or more humidity control devices. For example, when used with packages of cigarettes or hempettes, the pack may be increased in size to accommodate the standard quantity of 20 cigarettes and hempettes as well as one or more tubular humidity control devices packaged alongside the cigarettes or hempettes.

In some embodiments, the humidity control device may be a thin, flat and rigid sheet, such as a layered device, sized to fit in a small standard sized container. For example, the humidity control agent may be used inside a container such as a cigarette or hempette pack where it may be inserted and located between rows of cigarettes or hempettes. Due to the thinness of the device, it may fit between the rows of cigarettes or hempettes within a standard pack container. For example, the device may be very thin, such as about 0.01 to about 0.06 inches thick, or about 0.02 to 0.04 inches thick, or about 0.02 to about 0.03 inches thick. Depending upon the embodiment, it may contain about 0.5 to about 10 g of a humidity control agent, or about 1 to about 7 grams of a humidity control agent, or about 1 to about 5 grams of a humidity control agent, or about 1 to about 3 grams of a humidity control agent, or about 1 to about 2 grams of a humidity control agent. In some embodiments, the device may be a thin sheet with a large surface area, such as a sheet that is sized to fit within a container while having a length and width which extends across a majority of interior length and/or width of the container or is approximately equal to the interior length and/or width of the container or has a length and/or width sized between approximately half of or the entire interior length and/or width of the container. For example, the device may include a thin absorbent pad, such as a woven or non-woven material such as cellulose, rayon, cotton, or other polymeric material produced in such a fashion as to enable it to readily absorb aqueous solutions. The saturated solution treated pad may be laminated between layers of permeable barrier film that will transmit moisture vapor but not liquid solution.

In some embodiments, the thin flat humidity control device such as the one described above may be inserted into the container before, during, or after the container is filled with product and may be included in the same space as the product. In other embodiments, the thin flat humidity control device may be inserted into and/or located between layers of the container outside of the product space. For example, the thin flat humidity control device may be used with cigarette or hempette packs which include a box with an inner liner such as a foil liner which holds the cigarettes or hempettes and/or an outer wrap such as a cellophane wrap which surrounds the pack. In such embodiments, the thin flat humidity control device may be located between the layers of cigarettes or hempettes, between the inner liner and the box, and/or between the box and the outer liner. Although such spaces are limited, by being very thin and having a large surface area, such devices may still fit within the small space while providing the desired humidity control.

In other embodiments, the humidity control solution may include components that harden the solution such that it may or may not include or require a pouch or carrier. For example, in some embodiments, the device may be thickened into a texture like a gummy candy or a or putty. The humidity control solution may be thickened through the use of gelatin, pectin and/or a gum, such as xanthan gum, for example.

In some embodiments, the device may include a component which hardens in response to humidity. For example, the solution may include a component such as sorbitol which hardens in response to a decrease in humidity. In such embodiments, a user may test the device for exhaustion by touching it to determine whether replacement is necessary, such as by manually poking or pressing on it or bending it to feel the resistance. If the user detects that the device has changed and is harder or more rigid than it should be, the user may replace with device with a new device.

In some embodiments, the device may be activated by the user. The break-to-activate design may be used to transport and store the water activity control formula in an unused state between the time of production and the time of use by the consumer. Since the device remains inactive until needed by the user, its useful lifespan may be extended. For example, a user may flex or bend the device to activate it. The process of flexing or bending the device may release certain components which may be contained in a breakable compartment until released by flexing or bending the device to open or break the compartment. For example, the humidity control device may include at least two compartments which are not in communication with each other. However, upon manipulation by a user, one compartment may break or rupture, or the blocked location of communication/connection between the two compartments may rupture or otherwise become open, allowing contact between and mixture of the components in the first compartment with the components of the second compartment. For example, one compartment may include a liquid component such as water, ethylene, and/or other fluid, either alone or in combination with other components including dissolved components. Another separate component may contain dry components such as the salts or sugars that form the saturated solution when combined with the liquid component. When the activated by the user, the components of the two compartments come together. The user may also shake the device, after the compartments are connected by activation.

An example of an embodiment of a humidity control device which is configured to be activated by a user is shown in FIG. 2. The device 200 includes a first compartment 202 with may include an end cap 204 to assist in loading the compartment. The first compartment 202 encloses a space 206 which contains a first portion of the humidity control solution. A second compartment 210 is also enclosed in space 206 in the first compartment and itself encloses a second space 212 which contains a second portion of the humidity control solution. The material of the first compartment is flexible, while the material of the second compartment 210 is rigid and cracks or breaks when flexed. As such, when a user bends or squeezes the device 200, the material of the second compartment breaks such that the contents of the first and second compartments are no longer separated but rather can mix together to form a complete humidity control solution. The user may also shake the device 200 after breaking the compartment to assist in mixing the components.

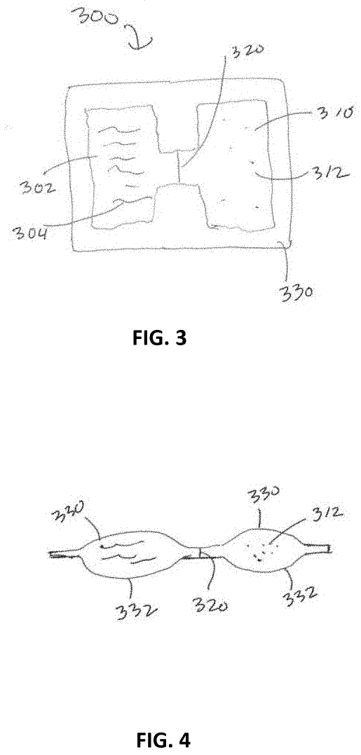

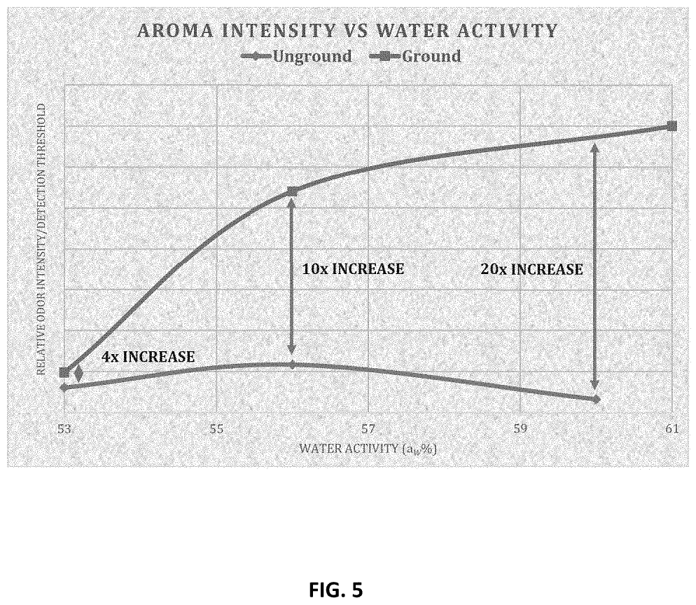

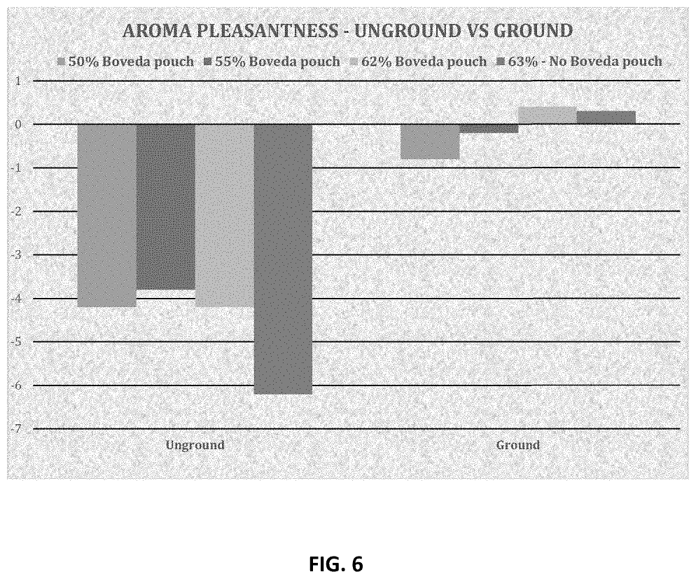

Another example of a humidity control device which is configured to be activated by a user is shown in FIGS. 3 and 4. The device 300 is a layered packet type of device including a first compartment 302 enclosing a first space 304 containing a first portion of the humidity control solution and a second compartment 310 enclosing a second space 312 containing a second portion of the humidity control solution. A channel connects the first space 304 to the second space 312 but passage between the two spaces is blocked by a barrier 320. As can be seen in the side view in FIG. 4, the device 300 is a layered structure formed of a top layer 330 and bottom layer 332 sealed around their edges to enclose the first and second spaces 314, 312, except at the connecting channel. The barrier 320 may be a thin and breakable material such that manipulation of the device 300 by a user is adequate to break the barrier 320 and allow the components from each compartment to mix together and form the complete humidity control solution. For example, the user might activate the device 300 by squeezing the compartment which includes water, causing an increase in pressure in that compartment and pushing the water against the barrier 320 until it ruptures. The user may then repeatedly squeeze and release one or both sides of the device 300 to assist in mixing the components.

Some embodiments provide not only humidity control but other environmental controls as an alternative to or in addition to humidity control. For example, the device may include an oxygen control agent which may absorb oxygen in the enclosed environment. The oxygen scavenger material that serves to scavenge oxygen may be compatible with the present system of saturated salt solution. One such scavenger material is a reduced powdered iron. The oxygen control agent may reduce residual oxygen or oxygen that diffuses through the product packaging to maintain an oxygen level well under 1%, a level at which molds cannot grow. For example, in some embodiments, the device may include an oxygen absorber such as an oxygen scavenger. The oxygen scavenger material may be any material that will capture oxygen at a desired rate and serve to maintain the oxygen level in a suitable range. When reduced powdered iron is used, the amount of reduced iron in the filling may depend on the amount of oxygen removal desired (measured in milliliters) and the amount of filling in the particular humidity regulator pouch. For example, if an 8-gram pouch must remove 100 ml of oxygen, the filling may include approximately 41 g of iron powder per kilogram of filling, or about 0.33 g of iron per pouch. The oxygen scavenger material may further include ferrous sulfate, manganous sulfate and sodium carbonate or a pH buffer system to maintain a pH of at least 7.75 to prevent reaction of the iron powder to produce hydrogen gas. Various examples of materials which may be used for oxygen control are disclosed in U.S. Pat. No. 9,750,811, entitled devices and methods for controlling headspace humidity and oxygen levels, the relevant portions of which are hereby incorporated by reference. Other oxygen absorbing materials may alternatively be used.

It may be desirable, such as in the instance of a food humidor holding 4, 6 or 8 foods, for example, to provide a pouch that is capable of passing at least 0.75 grams of water vapor per 24-hour period. This will permit maintenance of the proper humidity in the humidor with the humidor being opened up to five times in an environment of less than 30% relative humidity. In most use situations of the present invention a preferred water vapor transmission rate may be in the range of 1 to 3 grams per day per for a conventional pocket wood humidor. The preferred water activity may be 65 to 95, and the more preferred may be 75 to 85. This may allow for a reasonably quick restoration of equilibrium in the chamber, e.g., about 2 hours.

The water vapor transmission rate (WVTR) is determined by the type of film used and the thickness of the film, and any of the various films described herein as well as other films may be used in various embodiments. The total transmission is also affected by the area exposed to the chamber as well as the solution. For example, a 0.5 mu polyvinylchoride film will transmit about 8 grams per 100 square inches in 24 hours, while a 1.0 mil film of the same material will transmit about 3 or 4 grams in the same time period. The latter may be the lower end of the practical range for many uses.

In some embodiments, the rate may be approximately 10 grams moisture per 100 square inches per 24 hours. The usable (practical) range for many applications is 5 to 15 grams per 100 square inches per 24 hours. Some embodiments may use rates as low as 0.1 grams per 100 square inches per 24 hours, such as if a necessity exists to maintain a humidity level in a chamber that has very little, if any, permeation of moisture vapor through the walls or if the pouch has a large surface area.

In some embodiments, it may be useful to have a very large rate, i.e., 15+ grams per day. However, in some embodiments, undesirable seeping may occur if the transmission rate exceeds 25 grams per 100 square inches per day. Using a good firm gel inside of the pouch may mitigate this seepage problem significantly. A film resin extruded on a suitable substrate has demonstrated WVTRs of 15 to 25 with film thicknesses of 1.5 to 0.75 mu. Other films may be used with similar or higher WVTRs and may be suitable for these applications.

In many embodiments, an important function is to get as much transmission of vapor as possible and practical because it is preferable to reestablish equilibrium in a chamber as quickly as possible. In such cases, the higher the transmission rate, the better the performance in retaining the proper moisture level in the material being protected in the chamber. The preferred range of water vapor transmission may be on the order of 1 to 3 grams per day for restoration and maintenance of humidity in a 2 inch by 4 inches by 10-inch chamber where foods are stored, for example.

While one could make a humidity controller with a surface of 100 or more square inches, these would be rather cumbersome and awkward to employ. If the film passes 5 to 10 grams of water vapor per 100 square inches in 24 hours, one may only need to make a pouch of approximately 10 to 20 square inches to fulfill the performance requirements, for example.

Typical films that may be useful in various embodiments include food wrap films of polyvinylchloride, microfiberous polyethylene, microporous polyethylene, high density polyethylene, oriented polystyrene, cellophane, polycarbonate, and the like such as materials that have WVTR of 3 grams or more.

Further advantages of the devices described herein include the ability to regulate humidity in environments or with products having an increased or decreased temperature. Various devices may be used in combination with phase change materials as part of a heating or cooling device. Phase change materials, or PCMs, are useful for modulating temperature changes during heating and cooling and are typically provided in packets which may be used to regulate the temperature of consumable products such as foods and beverages as well as for medical purposes, such as cold or heat therapy, medical device and medical supply transport, as well as other uses, to maintain or alter the temperature of the product or material with which it is used. The PCMs absorb heat by melting as they transition from a solid to a liquid during temperature increases, and release heat by freezing as they transition from a liquid to a solid during temperature decreases. The PCMs used in various embodiments may be in the form of a continuous material, or the PCM may be a microencapsulated PCM or a macroencapsulated PCM of various sizes. Examples of PCM's which may be used in various embodiments include but are not limited to sodium formate and sorbitan laurate.

Such PCMs, whether or not they are encapsulated, may be encased within one or more layers of material to form a pack. The one or more outer layers may be flexible, particularly when they are used as a heating or cooling pack on a body for medical therapy. Alternatively, the one or more layers may be rigid, or the pack may include a combination of flexible and rigid outer layers. In some embodiments, the PCM may be encased in the pouch material of the device.

In various embodiments, the devices described herein may be used in combination with a PCM heating or cooling pack as a moisture control PCM heating or cooling pack. In some embodiments, the moisture control heating or cooling pack may include a first component which is a moisture control device and a second component which is a heating or cooling pack. These two components may be adjoined to form a single moisture control heating pack or moisture control cooling pack. For example, the outside of the pouch of the moisture control device may be adhered to the outside of the outer layer of the heating pack or the cooling pack, such as through the use of an adhesive.

In other embodiments, the moisture control solution may be incorporated into the heating or cooling pack, without the one or more outer layers of the heating or cooling pack. For example, the moisture control solution may be incorporated into the phase change material. In such embodiments, the outer layer or layers of the heating or cooling pack may be a liquid impermeable and vapor permeable material as described herein for use in the moisture control device pouch. Alternatively, the phase change material and the moisture control solution may be separate from each other, within the one or more outer layers. For example, the PCM and the moisture control solution may be in separate compartments within the device or may be separated by an impermeable layer of material between them. In such embodiments, at least a portion of the outer layer of the device which overlies the moisture control solution may be a water vapor permeable and liquid impermeable material as described herein. The portion of the outer layer covering the PCM may also be a water vapor permeable and liquid impermeable material, such as the same material covering the moisture control solution, or it may be a different material such as a water vapor and liquid impermeable material.

In other embodiments, the humidity control devices described herein may be used in cold environments, such as freezers, to prevent frost formation and freezer burn. For example, the humidity control devices may be used to prevent the formation of ice crystals in frozen foods such as ice creams and other frozen dairy and non-dairy desserts, frozen meat, frozen fish and seafood, and frozen prepared foods such as frozen dinners and frozen corn dogs.

In some embodiments, the humidity control device may be incorporated into the product package, such as the outer food package. For example, the humidity control device may be adhered to an inner wall of the food package. In food packaging in which the food item is loose within the package, a humidity control device adhered to an inner wall of the food package may occupy the same enclosed air space environment as the food. However, in food packaging which includes an outer package as well as one or more inner packages which contain the food, the humidity control devices may be adhered to an inner wall of the one or more inner packages within the same enclosed air space as the food. Alternatively, in some embodiments, the humidity control device may be loose within the package in the same enclosed space as the food.

In some embodiments, the humidity control device may be inserted into or adhered onto the package by the manufacturer. In such embodiments, the humidity control device may be present in the package at the time the consumer purchased the package. In other embodiments, the humidity control device may be purchased separately by a consumer and added to the package by inserting it into the food space, such as after the first time the package is opened, prior to closing the package and returning it to the freezer. The humidity control device may be left in the food storage space of the package by the user when the unused portion of the food is returned to the freezer. Alternatively, a consumer may add the humidity control device to a home use package such as a resealable plastic bag, such as a press seal back like a ZIPLOCK style bag, or other food container such as a food container with a snap close lid like a TUPPERWARE style container, along with fresh food to be frozen for preservation, including consumer prepared food items and fresh food items.

The humidity control devices used in frost prevention with frozen items may be provided to a consumer in an active state with the pouch exposed to the environment, or they may be provided in a sealed package, ready to be activated for use upon removal from the sealed package by the consumer. For example, when the humidity control device is provided by a manufacturer in a food product package, the humidity control device may be actively controlling the humidity of the enclosed food space even prior to purchase by a consumer, such as during transportation and while at the grocery store. Alternatively, the humidity control device may be provided with the food product package, such as inside the food product package, but may be enclosed within a gas impermeable sealed package. A consumer may then open the gas impermeable sealed package to remove the humidity control device and place it in the food space of the product package after purchasing and opening the product package. In this way, the life span of the humidity control device for controlling humidity after the product is purchased and opened may be extended. The humidity control devices which are purchased separately by consumers may similarly be sealed within a gas impermeable sealed package at the time of purchase and may be opened as needed for use in a frozen food package at a later time.

Some frozen foods are provided to consumers in plastic or cardboard tubs with lids, with the frozen food occupying the entire tub space except the headspace between the top of the food and the lid. Examples of such food products include ice cream and frozen dairy or non-dairy topping. During storage, ice crystals may form on the upper surface of the food, making the food less palatable. Various embodiments described herein reduce or prevent such as ice crystal formation through the use of a humidity control device in the package headspace, such as by adhering it to the inside of the lid.

The humidity control device may optionally include an outer case which may be of any suitable size and shape. For use with small packages containing only 3 or 4 foods, the device may be rather small for example 2 to 5 inches in length and perhaps ½ inch to 1 inch in diameter.

Alternatively, when a larger reservoir of moisture for humidity control is necessary, the pouch may be pillow-like of sufficient mechanical properties of substantially larger dimensions. For example, a pouch of 2.5 inches by 5.5 inches could contain about 2.5 ounces of solution or a pouch of 3.5 inches by 7 inches could contain about 4 ounces of solution. Much larger pouches can be designed to accommodate needs for large reservoirs such as for bulk storage of jerky. Pouches with dimensions larger than 5×5 may be segmented by incorporating a heat seal across one or both dimensions of the pouch to prevent the filling from collecting at the lowest part of the pouch during storage with the product.

Multiple pouches may be used in larger chambers (100 cubic inches) unless provisions are made to circulate the air in the chamber. For certain applications, the case may be of an impermeable material with a window of a film with suitable water vapor transmission properties. On the other hand, the case may be much larger for use in conjunction with a large number of foods, perhaps 8 to 10 inches in length and 1½ to 2 inches in diameter.

The case may be of any suitable material, for example, a polymer, metal, glass, ceramic, wood, etc. The material of the case may be flexible polyethylene, or a similar material, or a rigid polystyrene, or a similar material, for many applications. The case may also be made from netting or felt-like material such as paper, cloths, fur felt, plastic fibers, etc. However, other materials may be suitable as well. For example, wood may be used in expensive units where aesthetics are important.

The case may have an operable end portion for receipt of the pouch and salt solution. The internal container zone may be for example circular, rectangular, or triangular in cross section. The device may even be spherical in shape. Generally, it is advantageous to have maximum surface area per unit volume. The wall of the case may have defined therein a one or more small openings. In one preferred embodiment the openings were oval in shape being approximately 1/16 inch by ⅛ inch in open area. The openings may be provided adjacent to each other or in any pattern with sufficient adjacent wall structure to provide the strength and protection desired to prevent damage to the pouch. In some embodiments, the openings in the case may be 20% or the case. The strength requirement is dependent on the application and the abuse to which the case may be subjected.

In some embodiments, the humidity control device may include a visual indicator to provide information to a user about the condition of the humidity control device. For example, the visual indicator may indicate that the device has absorbed a maximum amount of water vapor or has released a maximum amount of water vapor and needs to be replaced. The visual indicator may provide this information through the use of symbols, colors, or other visual methods. In such embodiments, a moisture sensitive chemical may be used to make a significant, perceptible change with the indicated relative humidity is exceeded, for example. In some embodiments, the moisture sensitive chemical may be cobalt-chloride or may be cobalt free. In some embodiments, the information may be provided through the use of colors, such as colored printing and/or shapes such as dots, which may appear or change color depending upon the status of the device. For example, a green color may indicate that the device is in good condition, a yellow indicator may indicate that the device is in marginal condition and nearing the end of its usefulness, and a red indicator may indicate that the device has reached the end of its usefulness and should be replaced. In some embodiments, the visual indicator may be incorporated into the device pouch, such as through the normal package printing.

In some embodiments, the visual indicator may be a transparent window in the pouch or case of the device. For example, a fluid line at the top of the humidity control solution may be visible through the transparent window. When the fluid line falls below an indicated level, such as a marked level, this may indicate to a user observing the humidity control device that the humidity control device has released an amount of moisture over time such that it may no longer be functioning adequately and should be replaced.

If desired, the present humidity control device may include a mechanism for securing the device in place such as in the food package. In some embodiments the mounting may be, for example, a hook and loop mechanism in the package. Alternatively, it may include an adhesive.

In some embodiments, the device may be used to control the humidity of dried tea leaves, such as loose tea or tea in tea bags, including regular tea such as black tea or green tea as well as specialty tea such as herbal tea, at a desired relative humidity such as a relative humidity of about 32%. The device may not only preserve the tea in an optimal condition but may also preserve the fragrance of the tea. In addition, maintaining a level of hydration in the tea during storage may allow for rapid rehydration and a full robust brew when it is used for making tea.

Various embodiments may also be used for the preservation of coffee, such as whole coffee beans which may be roasted or unroasted or ground coffee beans, at a desired relative humidity such as a relative humidity of about 32%. Use of the humidity control device may help retain the flavor and fragrance of the coffee and minimize oxidation. For example, the device used with coffee may include humidity control as well as oxygen absorbing components.

In still other embodiments, the humidity control device may aid in maintaining the crunchy quality of fresh foods. Such devices may include humidity control and oxygen absorbing components and may be used with nuts such as pistachios, walnuts, peanuts, and pecans as well as other crunchy foods such as specialty items like edamame. The humidity control devices may also aid in maintaining the crispiness and freshness of foods such as vegetables that tend to wilt like carrots, lettuce, and celery. For example, devices for use with nuts may maintain the relative humidity at about 70%. Devices for use with fresh fruits and vegetables may maintain the relative humidity at about 90%, while those for use with dried fruit such as raisins may maintain the relative humidity at about 70%. When used with drier foods such as cereals and coffee beans, the humidity control devices may maintain humidity at around 30%.

Various embodiments of the humidity control device may be tested by consumers using a kit. The kit may include at least two airtight containers for storing a product such as tobacco, cannabis, or hemp. The kit may further include a grinder. The kit may further include at least one humidity control device. A user may use the kit by adding a quantity of product to a first airtight container and adding approximately the same quantity of product to a second airtight container. In one example, the product stored in the containers is cannabis flower. The user may add one or more humidity control devices to the first container, while leaving the second container without a humidity control device. Both of the containers may then be sealed and set aside for a period of time. After the period of time has passed, the user may open the two containers and compare the products in each container, for characteristics such as the appearance, feel and aroma of the product. The user may then grind a portion or all of the product from the first container, and separately grind a similar portion or all of the product from the second container. The ground products may then be compared against each other again. If the user notices a greater aroma in the product stored with the humidity control device this may indicate improved preservation due to the humidity control device. By grinding the product, this difference in aroma may be even more pronounced.

Operation of the Present Invention

The present invention may be used by a manufacturer or a user such as a consumer placing the device in a location in which it will control humidity and/or provide other environmental controls, such as within a product container such as a food package or other package. It may, for example, simply be loose within the container or adhered to the wall of the container. After the device is positioned inside the package, the package may be sealed against humidity and/or oxygen in the environment.

If humidity is above the certain humidity characteristic of the salt solution, the water vapor will be removed from the air and held within the salt solution until the humidity has returned to the predetermined point. On the other hand, if the air surrounding the device falls below the characteristic humidity point, water vapor will be given off by the salt solution so the air will return to that point.

### Example 1

An experiment was performed to determine the impact of relative humidity on aroma preservation in hemp.

The tests were performed using hemp strain Charlotte's Sauce from CBD Hemp District in Las Vegas, Nev. The initial a_{w} of the hemp was between 0.64 and 0.65. It was held at ambient conditions for 1-2 weeks prior to the start of the experiment, at which time the a_{w} of the hemp had equilibrated to 0.62-0.63.

Four random samples of 60 grams each were selected from the equilibrated hemp. Each sample was weighed and placed in a separate airtight, sealed, stainless steel container. Container 1 was the control in which the hemp was sealed with no additional treatment. In container 2 the hemp was sealed with a Boveda RH 50 sachet. This sachet included 39.65% water, 41.5% sodium formate, 18.5% glycerin, and 0.35% xanthan gum. In container 3, the hemp was sealed with a Boveda RH 55 sachet including 31.5% water, 0.35% gum 0.35%, 57.1% potassium citrate 57.1%, and 11% potassium acetate 11%. In container 4, the hemp was sealed with a Boveda RH 62 sachet which included 34.30% water, 64.35% potassium citrate, 0.99% glycerin, and 0.35% xanthan gum 0.35%. The containers were stored at standard laboratory conditions (72 degrees F., 35-40% RH) and light exposure was kept to a minimum. The hemp in each container was then separated into two different treatment arms. As described further below, the samples in treatment arm 1 were left whole, while those in treatment arm 2 were ground after storage. In this way, the samples in treatment arms could be compared for hemp stored under various conditions as providing measurements before and after grinding.

In treatment arm 1, after one week in storage, approximately 30 grams of hemp was removed from each container and quickly transferred to separate 0.05 mm thick TEDLAR aroma barrier bags, each outfitted with a 2-way valve. (The remaining 30 grams of hemp remained in each container for subsequent use in treatment arm 2 as described later below.) The hemp from container 1, the control, was sealed in the barrier bag alone and is sample 1. The hemp from containers 2, 3 and 4 were added to the bags along with a Boveda RH 50, 55, and 62 sachets, respectively, and are identified as samples 3, 5, and 7 as shown in the table 1 below. The bags were sealed using a GRIPSTIC sealing rod, then delivered to a sensory testing facility where the bags were filled with zero-odor air utilizing the 2-way valve.

After a 24-hour equilibration period, the headspace of each bag was transferred to another empty, odor free sealed TEDLAR bag utilizing the 2-way valve. The transferred headspace samples were then utilized for olfactory testing.

In treatment arm 2, the hemp that remained in the containers was stored for one additional week. The remaining approximately 30 grams of hemp from each container was ground using a NINJA. Each ground sample was then transferred quickly to a 0.05 mm thick TEDLAR aroma barrier bag outfitted with a 2-way valve. The bag was sealed using a GRIPSTIC sealing rod, then delivered to the sensory testing facility where the bags were filled with zero-odor air utilizing the 2-way valve. The hemp from container 1 (the control) is sample 2. The ground hemp from containers 2, 3 and 4 are samples number 4, 6, and 8, respectively.

The treatments applied and the samples created are summarized in table 1 below

TABLE 1

| | | Treatment | Initial | |
|---|---|---|---|---|
| | | arm | storage | |
| Container- | Treatment arm | 2-ground | Time | Sample |
| initial storage | 1-whole flower | flower | (weeks) | ID |
| 1-hemp alone | Hemp alone | | 1 | 1 |
| | | ground | 2 | 2 |
| 2-hemp with | Hemp with Boveda RH | | 1 | 3 |
| Boveda RH 50 | 50 | | | |
| | | ground | 2 | 4 |
| 3-hemp with | Hemp with Boveda RH | | 1 | 5 |
| Boveda RH 55 | 55 | | | |
| | | ground | 2 | 6 |
| 4-hemp with | Hemp with Boveda RH | | 1 | 7 |
| Boveda RH 62 | 62 | | | |
| | | ground | 2 | 8 |

For each of the samples, after a 24-hour equilibration period, the headspace of each bag was transferred to another empty, odor free sealed TEDLAR bag utilizing the 2-way valve. The transferred headspace samples were then utilized for olfactory testing. The detection threshold (DT) was determined by ASTM E679 and EN13725. It is a dimensionless ratio at which half of the assessors detect diluted air as different from blank or odorless air. The results of the olfactory testing are shown below in Table 2.

TABLE 2

| | | | | | | Detection |
|---|---|---|---|---|---|---|
| | | | | | | threshold |
| | | Relative | a_{w} at | | Average | ratio, |
| | Sample | Humidity | time | | detection | ground |
| Sample | weights | protection | of | Flower | threshold | to |
| ID | (g) | applied | testing | condition | (DT) | unground |
| 1 | 30.1 | None | 0.63 | Unground | 1,300 | 19.2 |
| 2 | 30.0 | | 0.64 | Ground | 25,000 | |
| 3 | 29.8 | 50% | 0.53 | Unground | 2,300 | 4.3 |
| 4 | 28.6 | | 0.53 | Ground | 9,900 | |
| 5 | 30.3 | 55% | 0.56 | Unground | 3,100 | 10.3 |
| 6 | 28.6 | | 0.56 | Ground | 32,000 | |
| 7 | 29.7 | 62% | 0.60 | Unground | 1,900 | 21.0 |
| 8 | 30.2 | | 0.61 | Ground | 40,000 | |

These results demonstrate that as the relative humidity of the sample storage conditions decrease (as reflected by the a_{w}), the level of fragrance compounds released from the surface of the hemp as evidenced by the aroma in the headspace of the unground samples increases, which indicates a higher level of aromatic compound release. That is, increasing the relative humidity towards a safe maximum storage relative humidity value such as 55-65% for cannabis, per ASTM D8197, suppresses evaporation of terpenes. The same trend is seen in the controlled humidity samples, 4, 6, and 8, ground just prior to olfactory analysis indicating that as the water activity increases, a higher level of terpenes is preserved within the internal mass of the hemp.

In addition, control sample 2, which was not stored in controlled humidity, has a lower level of aroma compounds present in the mass of the hemp compared to sample 8 as shown by grinding the samples prior to olfactory analysis resulted in a somewhat lower net aroma. It is believed that this is due to the higher level of water vapor present in the RH protected sample trapping the aroma compounds within the mass of the hemp. In the case of sample 2, the water activity of 0.64 is reached by evaporation of water from within the hemp into the sealed container. Co-evaporation of aroma compounds with the water from the mass and surface of the hemp in the control sample results in a lower level of aromatic compounds both in the ground and unground samples. This may be due to co-evaporation of water and terpenes during storage as the moisture of the plant biomass in the control sample results in less net aromatic compounds available for release upon grinding.

The results further demonstrate the impact of higher relative humidity levels on aroma preservations. Samples with an a_{w} of 0.60 and higher exhibited a twenty-fold increase in aroma after grinding, which indicates that higher RH reduced aromatic compound loss to a greater extent with RH protection. That is, the mass (or aromatic compounds) available for olfactory detection was substantially greater after storage at RH greater than 60, particularly when the relative humidity was supplied from an external source as described herein.

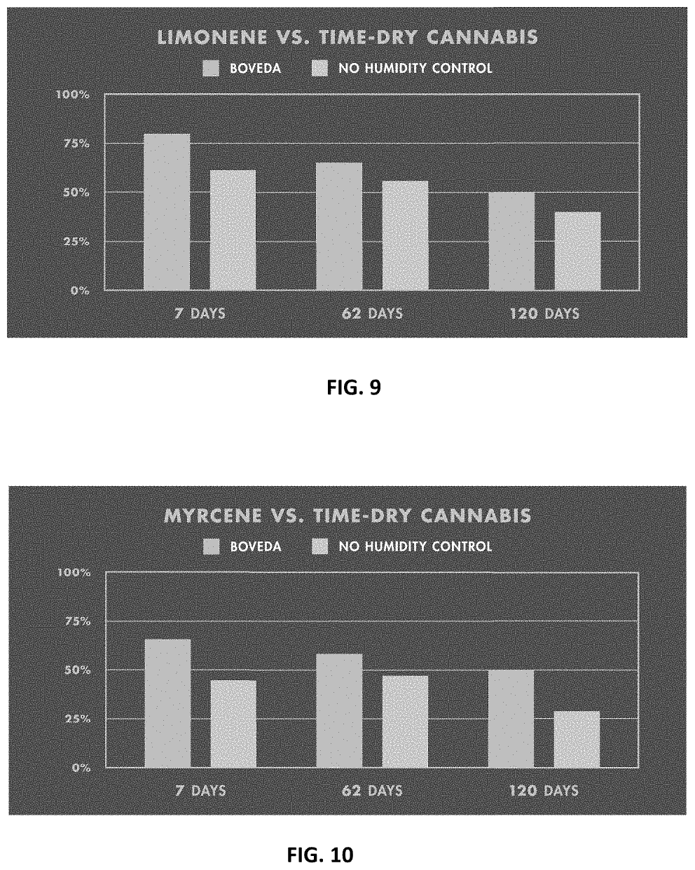

For samples 3 and 4 stored at 50% relative humidity, when compared to the control samples 1 and 2 at 63-64% relative humidity, there was an approximately 60% decrease in aroma intensity after grinding (9,900 for the samples stored at 50% relative humidity, versus 25,000 for the control samples). This suggests that at the relative humidity level of 50%, terpenes were volatizing due to the lack of formation of a monolayer of water on the hemp trichomes. The data also show that at 55% relative humidity, the aroma intensity was 1.3 times greater than the control (32,000 vs. 25,000) while at 62% relative humidity, the aroma intensity was 1.6 times greater than the control (40,000 vs 25,000). This suggests that the monolayer began to form on the hemp trichomes at around 55% relative humidity, with full formation by 62%. The data further show that the aroma intensity was greater in the ground than in the unground samples by 4 times (2,300 to 9,000), at 50% relative humidity by 10 times (3,100 to 32,000) at 55% relative humidity, and by 20 times (1,900 to 40,000) at 62% relative humidity. The increase in aroma intensity is shown in the graph provided in FIG. 9, in which aroma intensity is plotted against water activity for the unground and ground samples.

The pleasantness of the aroma of the ground and unground samples was also evaluated as part of the olfactory testing. The samples were rated by a pool of 40 assessors for various aroma descriptors on a scale of 1 (weakest) to 10 (strongest) and for pleasantness on a scale of −10 (most unpleasant) to 10 (most pleasant). The average results of the unground samples are shown in Table 3, while those of the ground samples are shown in Table 4, both below.

TABLE 3

| Aroma | | | | |
|---|---|---|---|---|
| Descriptor | Sample 1 | Sample 3 | Sample 5 | Sample 7 |
| Burnt | 7.35 | 5.58 | 4.80 | 5.40 |
| Sulfur | 6.75 | 4.33 | 4.15 | 4.08 |
| Animal | 4.28 | 3.58 | 2.60 | 3.85 |

TABLE 4

| Aroma | | | | |
|---|---|---|---|---|
| Descriptor | Sample 2 | Sample 4 | Sample 6 | Sample 8 |
| Wood | 3.50 | 3.15 | 2.68 | 3.13 |
| Sulfur | 1.93 | 2.90 | 2.03 | 0.83 |
| Herbal | 1.15 | 1.28 | 1.93 | 1.13 |
| Fruit | 1.28 | 0.50 | 0.75 | 1.78 |

The average results of the aroma pleasantness evaluation are shown in bar graph form in FIG. 10. The aroma pleasantness peaked between 55 and 62% relative humidity for unground samples, which correlates with the aroma intensity data presented in Table 2 and FIG. 9. The unground sample rated to have the least unpleasant aroma was sample 1 with the remaining samples having unpleasantness ratings of similar magnitude to each other. The unground sample which was rated to have the most unpleasant aroma of the test groups was sample 7, which was stored at 62% relative humidity. It is believed that the unpleasantness of the aroma is due to less terpenes having evaporated and the main component of the aroma is coming from plant biomass. That is, at 62% relative humidity, the monolayer of water was fully formed and prevented significant terpene evaporation in this sample.

After grinding, the aroma pleasantness increased significantly in the same manner as the aroma intensity increased, with the highest aroma pleasantness in sample 8 which was stored with relative humidity protection at 62%. For all of the samples, the relative pleasantness of the aroma increased as shown in FIG. 10, though only the control and sample 8, stored with relative humidity protection at 62% relative humidity, were classified as pleasant overall.

Tables 3 and 4 show that the aroma profiles changed greatly after grinding. In the unground samples, the aroma descriptions skewed toward unpleasant smells such as a burnt odor or very sulfurous. After grinding, the sulfur smell remained but it decreased as water activity increased due to humidity control, except in the control sample 2 which had no humidity control and which had a sulfurous aroma despite a high a_{w}. The other primary aroma descriptors such as herbal and fruity may be considered more pleasant and desirable fragrances and were present after grinding. This suggests that when the samples were unground, the primary aromas that were detected were related to the plant biomass rather than trichome terpenes that were present in the headspace. Once ground, the terpenes were released and overwhelmed the plant related aromas.

These results show that, for unground hemp flower, both aroma intensity and relative pleasantness reach a maximum between 55 and 62% relative humidity. This suggests that the formation of a monolayer of water, which helps prevent terpene loss, begins around 55% relative humidity, with full formation complete by around 62% relative humidity. After grinding, peak aroma intensity and pleasantness shifts toward 62% relative humidity.

### Example 2

This experiment was performed to assess the stability of terpenes in cannabis flower over time, when stored with and without humidity control.

The cannabis used in this experiment was Bacio Gelato strain obtained from Sherbinskis, located in San Francisco, Calif. The cannabis was freshly cultivated and cured with an initial a_{w} of 0.56, which is within the optimum a_{w} range of 0.55-0.65 according to ASTM D8197.

A portion of the freshly cured cannabis was carefully dried to lower the a_{w} to 0.50. This was done to accelerate evaporation and to challenge the cannabis sample. The initial moisture content and terpene profiles were then measured (n=5) to establish a baseline time of t=t0.

The cannabis was randomly divided into 6 subsamples, each having 30 g of flower. These were further divided into 5 replicates containing 6 g of flower each. These replicates were then weighed and placed individual airtight glass Mason jars. Finally, a Boveda pouch of relevant RH was weighed before being placed into the Mason jar. The sample conditions are summarized below in table 5.

TABLE 5

| Days | Sample | # of Replicates |
|---|---|---|
| 0 | Baseline | 5 |
| 7 | No humidity control | 5 |
| | Boveda RH 62 | 5 |
| 62 | No humidity control | 5 |
| | Boveda RH 62 | 5 |
| 120 | No humidity control | 5 |
| | Boveda RH 62 | 5 |

Except for the 7-day sample and the baseline sample, each jar was opened once a week for 30 seconds. This was done to simulate how an end user may open and close the container during normal use thereby refreshing the environment inside the jars.

For each time point and replicate, the following steps were carried out: the jar was opened and allowed to sit for 30 seconds; the cannabis was weighed, the humidity control pouch was weighed; the cannabis was ground; the a_{w} and moisture content were measured; and the terpene profile was measured.

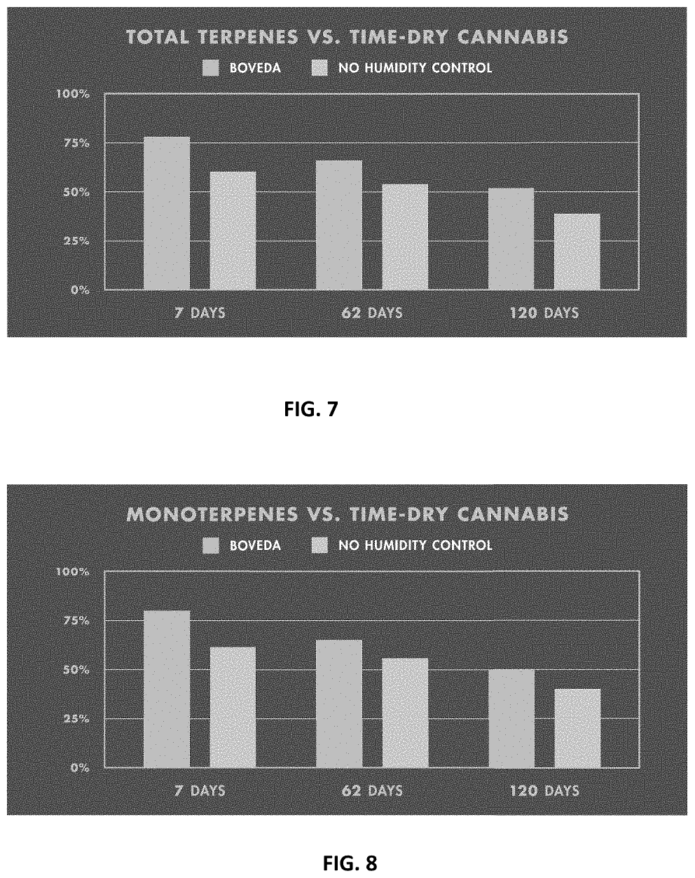

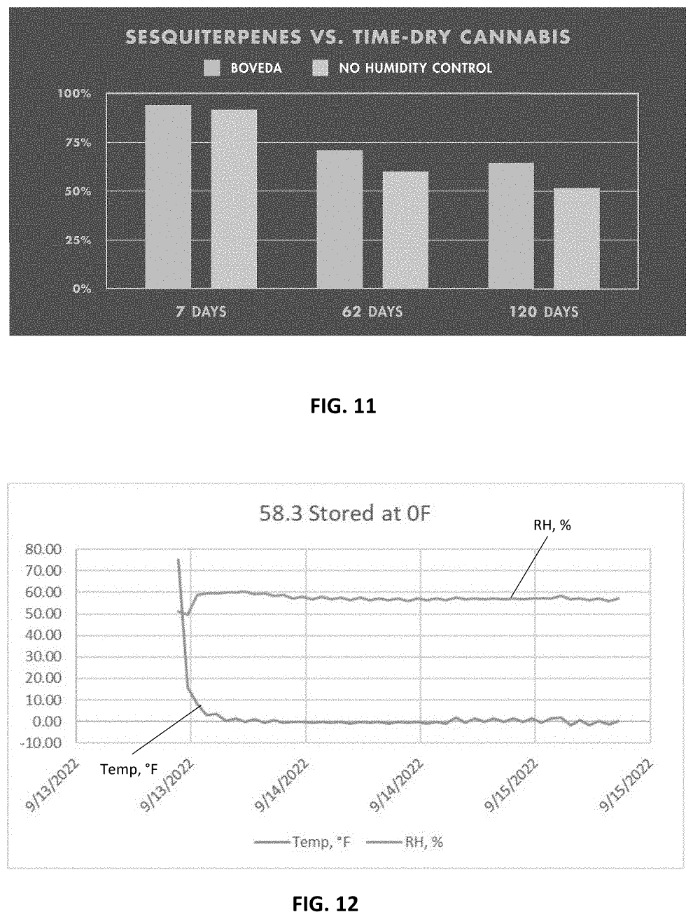

The results are shown in the bar graph provided as FIG. 7 through FIG. 11. FIG. 7 displays the total amount of terpenes in each sample, as a percentage of the amount of terpene present at t0, at 7, 62 and 120 days for the samples stored without humidity control as compared to those stored with the Boveda humidity control packet. The same results are shown in the other figures, but for the following specific terpenes: monoterpenes (FIG. 8), limonene (FIG. 9), myrcene (FIG. 10) and sesquiterpenes (FIG. 11). These results are also shown numerically in table 6, below.

TABLE 6

| | Total Terpenes | | Total Monoterpenes | | Total Sesquiterpenes | |
|---|---|---|---|---|---|---|
| | Preserved | | Preserved | | Preserved | |
| | No RH | Boveda | No RH | Boveda | No RH | Boveda |
| Days | Control | 62% | Control | 62% | Control | 62% |
| 7 | 60.2% | 78.2% | 58.9% | 77.6% | 93.4% | 94.2% |
| 62 | 54.8% | 65.3% | 54.6% | 65.2% | 59.4% | 69.9% |
| 120 | 39.7% | 51.2% | 39.3% | 50.8% | 51.4% | 59.3% |

As shown in the figures and in table 6, the cannabis flower stored with the Boveda humidity control packet preserved 78% of terpenes after 7 days, as compared to the cannabis flower stored without humidity control which preserved only 60%. After 7 days, the cannabis flower stored with the Boveda humidity control packet preserved 78% of monoterpenes while the cannabis flower stored without humidity control preserved only 59% of monoterpenes. The cannabis flower stored with the Boveda humidity control packet preserved 80% of limonene after 7 days, as compared to only 60% preservation in the sample stored without humidity control. Myrcene was 66% preserved in the sample stored for 7 days with the Boveda humidity control packet but was only 45% preserved in the sample stored without humidity control. Finally, after 120 days, the sample stored with the Boveda humidity control packet had 59% preservation of sesquiterpenes, but the sample stored without humidity control had 51% preservation.

These results demonstrate that the Boveda humidity control packet preserved 18% more of the total terpenes and 19% more monoterpenes after 7 days as compared to cannabis flowers stored without humidity control. In addition, cannabis flower stored without humidity control lost nearly half of all its terpenes at around 60 days. In comparison, flower stored with the Boveda humidity control packet took twice as long, 120 days, to reach that point. Without the Boveda humidity control packet, the freshly cured flower lost 40% of terpenes after 7 days and 60% after 4 months. Terpenes were preserved up to 8.5 times longer in flower stored with the Boveda humidity control packet versus flower stored without humidity control. After 120 days, the cannabis flower stored with the humidity control packet preserved 73% more myrcene than cannabis stored without humidity control.

### Example 3

A comparison of the humidity control provided by 62% humidity control pouches, with and without absorbent pads and with and without the inclusion of gum in the humidity control solution.

Pads were cut from a 2-ply nylon pad material having a thickness of 0.33 in the following sizes: 1.5 inch by 1.5 inch to fit into a 4 g Boveda humidity control pouch; and 2.25 inch by 2 inch to fit into an 8 g Boveda humidity control pouch.

Two 62% humidity control formulations were prepared, with and without gum. The 62% humidity control formulation with gum included 34.30% water, 65.35% potassium citrate, 0.99% glycerin, and 0.35% gum. The humidity control formulation without gum included 34.41% water, 65.58% potassium citrate, and 0.99% water.

Two of each type of pouch were prepared such that the pouches were tested in duplicate. The pads were inserted into the Boveda pouches (where applicable), and the pouches were hand filled with one or the other of the 62% humidity control formulations. The pouches were then heat sealed closed.

Leak down testing was performed on the pouches as follows. All weights were recorded to calculate weight loss of the solution. The initial weight was recorded, and the pouch was placed in a low humidity (<10% RH) and tested every 24 hours until weight no longer changed. The results are shown in Table 7-10, below.

A comparison of 62% humidity control solution with gum in 4 g pouches, with and without inclusion of an absorbent pad, is shown in Table 7 below. The humidity control pouch performed well both with and without the pad, with a similar percentage decrease in the weight of the solution on day 7.

TABLE 7

| | 4 g 62% (w/gum) | | | | | | | | | | | |
|---|---|---|---|---|---|---|---|---|---|---|---|---|
| | Pad | | | | | | No Pad | | | | | |
| | 1 | | | 2 | | | 1 | | | 2 | | |
| | Totl | Soln | % | Totl | Soln | % | Totl | Soln | % | Totl | Soln | % |
| Day | Wt | Wt | Loss | Wt | Wt | Loss | Wt | Wt | Loss | Wt | Wt | Loss |
| 1* | 4.80 | 4.07 | | 4.80 | 4.07 | | 4.56 | 4.06 | | 4.17 | 3.67 | |
| 2 | 4.36 | 3.63 | 11 | 4.44 | 3.71 | 9 | 4.18 | 3.68 | 9 | 3.71 | 3.21 | 13 |
| 3 | 3.96 | 3.23 | 21 | 3.96 | 3.23 | 21 | 3.81 | 3.31 | 18 | 3.34 | 2.84 | 23 |
| 4 | 3.74 | 3.01 | 26 | 3.68 | 2.95 | 28 | 3.58 | 3.08 | 24 | 3.13 | 2.63 | 28 |
| 5 | 3.57 | 2.84 | 30 | 3.49 | 2.76 | 32 | 3.35 | 2.85 | 30 | 3.02 | 2.52 | 31 |
| 6 | 3.45 | 2.72 | 33 | 3.43 | 2.70 | 34 | 3.22 | 2.72 | 33 | 2.99 | 2.49 | 32 |
| 7 | 3.43 | 2.70 | 34 | 3.43 | 2.7 | 34 | 3.22 | 2.72 | 33 | 2.99 | 2.49 | 32 |
| AVG | | | 34 | | | | | | 33 | | | |

*pouches 1 and 2 with pads included 4.07 g solution and 0.73 g pouch and pad combined; pouch 1 with no pad included 4.06 g solution and 0.50 g pouch; pouch 2 with no pad included 3.67g solution and 0.50 g pouch.

A comparison of 62% humidity control solution without gum in 4 g pouches, with and without inclusion of an absorbent pad, is shown in Table 8 below. The humidity control pouch again performed well both with and without the pad, with a similar percentage decrease in the weight of the solution on day 7.

TABLE 8

| | 4 g 62% (no gum) | | | | | | | | | | | |
|---|---|---|---|---|---|---|---|---|---|---|---|---|
| | Pad | | | | | | No Pad | | | | | |
| | 1 | | | 2 | | | 1 | | | 2 | | |
| | Totl | Soln | % | Totl | Soln | % | Totl | Soln | % | Totl | Soln | % |
| Day | Wt | Wt | Loss | Wt | Wt | Loss | Wt | Wt | Loss | Wt | Wt | Loss |
| 1* | 4.71 | 3.98 | | 4.74 | 4.01 | | 4.36 | 3.86 | | 4.35 | 3.85 | |
| 2 | 4.42 | 3.69 | 7 | 4.43 | 3.70 | 8 | 4.09 | 3.59 | 7 | 4.00 | 3.50 | 9 |
| 3 | 4.08 | 3.35 | 16 | 4.18 | 3.45 | 14 | 3.89 | 3.39 | 12 | 3.70 | 3.20 | 17 |
| 4 | 3.92 | 3.19 | 20 | 4.01 | 3.28 | 18 | 3.79 | 3.29 | 15 | 3.54 | 3.04 | 21 |
| 5 | 3.64 | 2.91 | 27 | 3.79 | 3.06 | 24 | 3.57 | 3.07 | 20 | 3.35 | 2.85 | 26 |
| 6 | 3.48 | 2.75 | 31 | 3.51 | 2.78 | 31 | 3.39 | 2.89 | 25 | 3.28 | 2.78 | 28 |
| 7 | 3.39 | 2.66 | 33 | 3.39 | 2.66 | 34 | 3.25 | 2.75 | 29 | 3.17 | 2.67 | 31 |
| 8 | 3.31 | 2.58 | 35 | 3.32 | 2.59 | 35 | 3.10 | 2.6 | 33 | 3.16 | 2.66 | 31 |
| AVG | | | 35 | | | | | | 32 | | | |

*Pouches 1 and 2 with the pad included 3.98 g and 4.01 g of solution, respectively, and 0.73 g pouch and pad combined; pouch 1 with no pad included 3.86 g solution and 0.50 g pouch; pouch 2 with no pad included 3.85 g solution and 0.50 g pouch.

A comparison of 62% humidity control solution with gum in 8 g pouches, with and without inclusion of an absorbent pad, is shown in Table 9 below. The humidity control pouch again performed well both with and without the pad, with a similar percentage decrease in the weight of the solution on day 8.

TABLE 9

| | 8 g 62% (w/gum) | | | | | | | | | | | |
|---|---|---|---|---|---|---|---|---|---|---|---|---|
| | Pad | | | | | | No Pad | | | | | |
| | 1 | | | 2 | | | 1 | | | 2 | | |
| | Totl | Soln | % | Totl | Soln | % | Totl | Soln | % | Totl | Soln | % |
| Day | Wt | Wt | Loss | Wt | Wt | Loss | Wt | Wt | Loss | Wt | Wt | Loss |
| 1* | 9.42 | 8.00 | | 9.42 | 8.00 | | 9.04 | 8.11 | | 9.00 | 8.07 | |
| 2 | 9.00 | 7.58 | 5 | 8.96 | 7.54 | 6 | 8.44 | 7.51 | 7 | 8.53 | 7.60 | 6 |
| 3 | 8.59 | 7.17 | 10 | 8.52 | 7.10 | 11 | 7.99 | 7.06 | 13 | 8.05 | 7.12 | 12 |
| 4 | 8.24 | 6.82 | 15 | 8.17 | 6.75 | 16 | 7.66 | 6.73 | 17 | 7.71 | 6.78 | 16 |
| 5 | 7.88 | 6.46 | 19 | 7.88 | 6.46 | 19 | 7.39 | 6.46 | 20 | 7.47 | 6.54 | 19 |
| 6 | 7.48 | 6.06 | 24 | 7.57 | 6.15 | 23 | 7.06 | 6.13 | 24 | 7.19 | 6.26 | 22 |
| 7 | 7.24 | 5.82 | 27 | 7.36 | 5.94 | 26 | 6.86 | 5.93 | 27 | 7.01 | 6.08 | 25 |
| 8 | 6.95 | 5.53 | 31 | 7.09 | 5.67 | 29 | 6.62 | 5.69 | 30 | 6.79 | 5.86 | 27 |
| AVG | | | 30 | | | | | | 29 | | | |

*Pouches 1 and 2 with pad included 8.00 g solution and 1.42 g pouch and pad in combination; pouch 1 without pad included 8.11 g solution and 0.93 g pouch; pouch 2 without pad included 8.07 g solution and 0.93 g pouch.

A comparison of 62% humidity control solution without gum in 8 g pouches, with and without inclusion of an absorbent pad, is shown in Table 9 below. The humidity control pouch again performed well both with and without the pad, with a similar percentage decrease in the weight of the solution on day 9.

TABLE 10

| | 8 g 62% (no gum) | | | | | | | | | | | |
|---|---|---|---|---|---|---|---|---|---|---|---|---|
| | Pad | | | | | | No Pad | | | | | |
| | 1 | | | 2 | | | 1 | | | 2 | | |
| | Totl | Soln | % | Totl | Soln | % | Totl | Soln | % | Totl | Soln | % |
| Day | Wt | Wt | Loss | Wt | Wt | Loss | Wt | Wt | Loss | Wt | Wt | Loss |
| 1* | 9.34 | 7.92 | | 9.35 | 7.93 | | 9.23 | 8.30 | | 9.19 | 8.26 | |
| 2 | 8.74 | 7.32 | 8 | 8.83 | 7.41 | 7 | 8.59 | 7.66 | 8 | 8.65 | 7.72 | 7 |
| 3 | 8.26 | 6.84 | 14 | 8.30 | 6.88 | 13 | 8.02 | 7.09 | 15 | 8.09 | 7.16 | 13 |
| 4 | 8.06 | 6.64 | 16 | 7.98 | 6.56 | 17 | 7.73 | 6.80 | 18 | 7.80 | 6.87 | 17 |
| 5 | 7.64 | 6.22 | 21 | 7.54 | 6.12 | 23 | 7.41 | 6.48 | 22 | 7.52 | 6.59 | 20 |
| 6 | 7.32 | 5.90 | 26 | 7.29 | 5.87 | 26 | 7.15 | 6.22 | 25 | 7.23 | 6.30 | 24 |
| 7 | 6.97 | 5.55 | 30 | 6.77 | 5.35 | 33 | 6.90 | 5.97 | 28 | 6.89 | 5.96 | 28 |
| 8 | 6.60 | 5.18 | 35 | 6.53 | 5.11 | 36 | 6.69 | 5.76 | 31 | 6.65 | 5.72 | 31 |
| 9 | 6.44 | 5.02 | 37 | 6.48 | 5.06 | 36 | 6.35 | 5.42 | 35 | 6.34 | 5.41 | 35 |
| AVG | | | 36 | | | | | | 35 | | | |

*Pouches 1 and 2 with pads included 7.92 and 7.93 g solution, respective, and 1.42 g pouch and pad combined; pouches 1 and 2 without pad included 8.30 and 8.26 g solution, respectively, and 0.93 g pouch.

### Example 4

In this example, the effectiveness of 58.3% RH Boveda pouches was tested at three temperatures over time. Three 60 g Boveda pouches were each filled with 60 grams of a solution of 51.50% water, 47.65% sodium formate, 0.50% glycerin, and 0.35% xanthan gum and then the pouches were heat sealed. The pouches were then placed in three different 8 oz canning jars, along with a hygrometer, and the lid of the canning jar was sealed.

The canning jars containing the Boveda pouches and the hygrometer were placed in one of three different temperature environments for 48 hours. One jar was placed in a zero-degree F. environment, which is at or close to a typical home freezer temperature. One jar was placed in a 32 degrees F. environment, which is at or close to a typical home refrigerator temperature. The remaining jar was placed in a 72 degrees F. environment, which approximates room temperature. At the end of the 48-hour period, the jars were opened, and the hygrometer readings were downloaded.

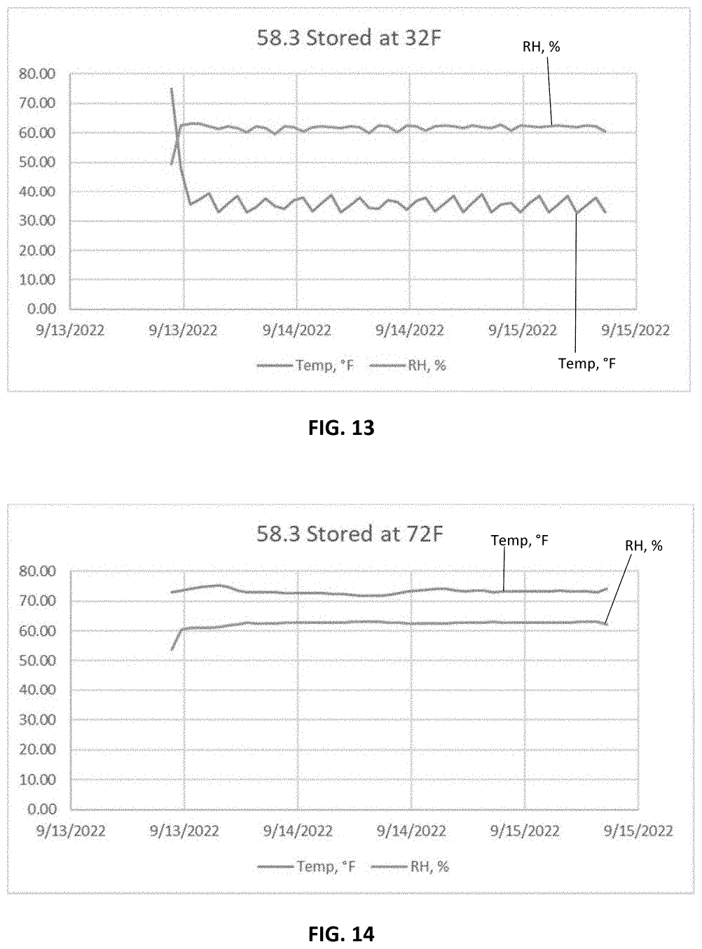

The data from the hygrometers and the temperature are plotted against time for each condition as shown in FIGS. 12 to 14. FIG. 12 shows the humidity control at 0 degrees F., FIG. 13 shows the humidity control at 32 degrees F., and FIG. 14 shows the results at 72 degrees F. As shown in the figures, at all temperatures, the humidity control device quickly brought the relative humidity to the approximate desired level and maintained it throughout the test, showing the effectiveness of the humidity control devices is not limited to room temperature environments but extends to refrigerator and freezer temperatures as well.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context.

However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A humidity control device comprising:
an aqueous saturated solution of a salt and/or a sugar in combination with an additive; wherein all components of the saturated solution are food grade.

2. The humidity control device of claim 1 further comprising a flexible pouch encasing the aqueous saturated solution, the pouch comprising a material which is moisture permeable and liquid impermeable.

3. The humidity control device of claim 2 wherein the aqueous saturated solution further comprises a thickening agent.

4. The humidity control device of claim 2 further comprising an absorbent pad within the pouch.

5. The humidity control device of claim 4 wherein the saturated solution does not include a thickening agent.

6. The humidity control device of claim 4 wherein the absorbent pad comprises blotter paper.

7. The humidity control device of claim 4 wherein the absorbent pad comprises a rayon material.

8. The humidity control device of claim 1 further comprising an absorbent pad, wherein the aqueous saturated solution is contained by pores of the absorbent pad without an encasing package.

9. The humidity control device of claim 1 further comprising:
a package comprising a first compartment and a separate second compartment, wherein the first and second compartments are not in communication with each other,
wherein prior to activation by a user, a first portion of the aqueous saturated salt solution including one or more first components of the aqueous saturated salt solution is contained within the first compartment, and
wherein a second portion of the aqueous saturated salt solution including one or more second components of the aqueous saturated salt solution is contained within the second compartment,
and wherein the first portion and the second portion are combined by activation by a user to form the aqueous saturated solution.

10. The humidity control device of claim 9 wherein the first compartment contains water and wherein the second compartment contains no water.

11. The humidity control device of claim 10 wherein the second compartment contains the salt and/or sugar.

12. The humidity control device of claim 1 wherein the aqueous saturated solution further comprises gelatin, pectin or a gum.

13. The humidity control device of claim 12 wherein there is no container enclosing the aqueous saturated solution.

14. The humidity control device of claim 1 wherein the humidity control device hardens in response to decreasing water in the aqueous saturated solution, the aqueous saturated solution further comprising sorbitol.

15. A method of controlling humidity in a closed container or package, the method comprising:
placing a humidity control device in the container or package, the humidity control device comprising an aqueous saturated solution of a salt and/or a sugar in combination with an additive; and
closing the container or package including the humidity control device,
wherein all components of the saturated solution are food grade, and
wherein the enclosed container also includes a consumable product.

16. The method of claim 15 wherein the consumable product comprises a food or a medicine.

17. The method of claim 14 further comprising storing the container or package with the enclosed the humidity control device in a refrigerator or a freezer.

18. A method of controlling humidity comprising:
activating a humidity control device, the humidity control device comprising:
a container comprising a first compartment and a second compartment,
the first compartment containing a content comprising water, and
the second compartment, separated from the first compartment, the second compartment containing a content comprising a salt and/or sugar;
wherein activating the humidity control device comprises manually altering the container to bring together the contents of the first and second compartments to form a saturated solution configured to control relative humidity;
placing the activated humidity control device in a location at which controlled humidity is desired.

19. The method of claim 18 wherein manually altering the container comprises breaking the first and/or the second compartment.

20. The method of claim 18 wherein the container further comprises a closed passage between the first and the second compartments, wherein manually altering the container comprises opening the passage between the first and the second compartments.
